(19) United States
(12) Patent Application Publication
(10) Pub. No.: US 2025/0065609 A1
(43) Pub. Date: Feb. 27, 2025

(54) MULTILAYER FILM AND USES THEREOF

(71) Applicant: PROCHIMIR, Pouzauges (FR)

(72) Inventor: Mathieu COSSET, Pouzauges (FR)

(21) Appl. No.: 18/718,140

(22) PCT Filed: Dec. 21, 2022
(86) PCT No.: PCT/FR2022/052457

§ 371 Date: Jun. 10, 2024

(30) Foreign Application Priority Data
Dec. 23, 2021 (FR) FR2114310

(51) Int. Cl. B32B 27/08; B29C 48/10; B29C 48/21; B29K 67/00; B29K 75/00; B29L 31/00; B32B 27/28; B32B 27/36

(52) U.S. Cl. CPC B32B 27/08; B29C 48/10; B29C 48/21; B32B 27/285; B32B 27/36; B29K 2067/00; B29K 2075/00; B29K 2995/007; B29L 2031/712; B32B 2250/24; B32B 2274/00; B32B 2307/536; B32B 2307/54; B32B 2307/7376; B32B 2307/748; B32B 2439/00

(57) ABSTRACT

The present invention relates to a multilayer film comprising:
an adhesive layer comprising a thermoplastic polyurethane elastomer selected from polyether-based thermoplastic polyurethane elastomers, polycarbonate-based thermoplastic elastomers, and mixtures thereof;
a barrier layer bonded to the adhesive layer, said barrier layer comprising a thermoplastic polyester elastomer;
   and also to the uses thereof.

### FIELD OF THE INVENTION

The present invention relates to a multilayer film and its uses, especially for preparing laminates.

### TECHNOLOGICAL BACKGROUND

Diverse mono- or multilayer films are available commercially, formulated from various polymers, for bonding between diverse substrates such as foams, metals, textiles, or else plastics. The polymers are typically polyamides, polyolefins, polyamide/polyester copolymers, thermoplastic polyesters, etc.

In the automotive field, multilayer films can be used for bonding parts inside the passenger compartment such as the headlining, seats, for decorative parts with assembly, or else for soundproofing parts (car floor carpet, trunk floor, engine hood, etc.). The films must be able to withstand time and the conditions of use, especially when exposed to high temperatures (parts close to the engine).

There is therefore a need for new multilayer films exhibiting good mechanical and adhesive properties over time.

There is a need especially for new multilayer films exhibiting mechanical and adhesive properties that are stable after aging at temperatures above the ambient temperature, especially in humid conditions, for example between 60° C. and 120° C. with a relative humidity of possibly up to 95%.

### DESCRIPTION OF THE INVENTION

The present invention relates to a multilayer film comprising:
an adhesive layer comprising a thermoplastic polyurethane elastomer selected from polyether-based thermoplastic polyurethane elastomers, polycarbonate-based thermoplastic elastomers, and mixtures thereof;
a barrier layer bonded to the adhesive layer, said barrier layer comprising a thermoplastic polyester elastomer.

The multilayer film according to the invention advantageously exhibits good mechanical and adhesive properties over time.

The multilayer film according to the invention advantageously exhibits mechanical and adhesive properties that are stable over time. Advantageously, the multilayer film exhibits good mechanical and adhesive properties up to a duration greater than or equal to 2000 h, or even 3000 h, after aging at 70° C. and 95% RH.

### Multilayer Film

### Adhesive Layer

The adhesive layer comprises a thermoplastic polyurethane elastomer chosen from polyether-based thermoplastic polyurethane elastomers, polycarbonate-based thermoplastic elastomers, and mixtures thereof.

The term “thermoplastic polyurethane elastomer” is well known to those skilled in the art, and is also designated by the initials “TPU”. It concerns a block copolymer comprising, in alternation, so-called hard or rigid blocks or segments, and so-called soft or flexible blocks or segments, with urethane bonds in the hard blocks and ether, ester or carbonate bonds (or mixtures of bonds) in the soft blocks.

A thermoplastic elastomer advantageously combines the elastic properties of elastomers and the thermoplastic character.

The thermoplastic polyurethane elastomer may be the reaction product of at least one polyol, a polyisocyanate, and optionally a chain extender.

The polyisocyanate may be chosen from diisocyanates or triisocyanates.

The polyisocyanate may be monomeric, oligomeric or polymeric.

According to one embodiment, the polyisocyanate is chosen from diisocyanates, preferably selected from the group consisting of isophorone diisocyanate (IPDI), hexamethylene diisocyanate (HDI), heptane diisocyanate, octane diisocyanate, nonane diisocyanate, decane diisocyanate, undecane diisocyanate, dodecane diisocyanate, 2,4′-methylenebis(cyclohexyl isocyanate) (2,4′-H6MDI), 4,4′-methylenebis(cyclohexyl isocyanate) (4,4′-H6MDI), norbornane diisocyanate, norbornene diisocyanate, cyclohexane 1,4-diisocyanate (CHDI), methylcyclohexane diisocyanate, ethylcyclohexane diisocyanate, propylcyclohexane diisocyanate, methyldiethylcyclohexane diisocyanate, cyclohexanedimethylene diisocyanate, 1,5-diisocyanato-2-methylpentane (MPDI), 1,6-diisocyanato-2,4,4-trimethylhexane, 1,6-diisocyanato-2,2,4-trimethylhexane (TMDI), 4-isocyanatomethyloctane 1,8-diisocyanate (TIN), 2,5-bis(isocyanatomethyl)bicyclo[2.2.1]heptane (2,5-NBDI), 2,6-bis(isocyanatomethyl)bicyclo[2.2.1]heptane (2,6-NBDI), bis(isocyanatomethyl)cyclohexane (H6-XDI) (in particular 1,3-bis(isocyanatomethyl)cyclohexane (1,3-H6-XDI)), xylylene diisocyanate (XDI) (in particular m-xylylene diisocyanate (m-XDI)), toluene diisocyanate (in particular toluene 2,4-diisocyanate (2,4-TDI) and/or toluene 2,6-diisocyanate (2,6-TDI)), diphenylmethane diisocyanate (in particular diphenylmethane 4,4′-diisocyanate (4,4′-MDI) and/or diphenylmethane 2,4′-diisocyanate (2,4′-MDI)), tetramethylxylylene diisocyanate (TMXDI) (in particular tetramethyl-m-xylylene diisocyanate), and mixtures thereof. The polyisocyanate is preferably an aromatic polyisocyanate. More preferably, the polyisocyanate is chosen from toluene diisocyanate (in particular toluene 2,4-diisocyanate (2,4-TDI) and/or toluene 2,6-diisocyanate (2,6-TDI)), diphenylmethane diisocyanate (in particular diphenylmethane 4,4′-diisocyanate (4,4′-MDI) and/or diphenylmethane 2,4′-diisocyanate (2,4′-MDI)), and mixtures thereof.

The polyisocyanate is typically available commercially. By way of example, mention may be made of SCURANATE® TX sold by the company VENCOREX, corresponding to a 2,4-TDI with a purity of the order of 95%, SCURANATE® T100 sold by the company VENCOREX, corresponding to a 2,4-TDI with a purity greater than 99% by weight, the DESMODUR® I sold by the company COVESTRO, corresponding to an IPDI, or else the DESMODUR® N3300 sold by the company COVESTRO, corresponding to an HDI isocyanurate.

In the context of the invention, and unless otherwise stated, the term “polyether-based thermoplastic polyurethane elastomer” is understood to mean a thermoplastic polyurethane elastomer whose soft segment comprises at least one polyether.

In the context of the invention, and unless otherwise stated, the term “polycarbonate-based thermoplastic polyurethane elastomer” is understood to mean a thermoplastic polyurethane elastomer whose soft segment comprises at least one polycarbonate.

The polyol may be chosen from polyester polyols, polyether polyols, polycarbonate polyols, and mixtures thereof; preferably from polyether polyols, polycarbonate polyols and mixtures thereof.

When the thermoplastic polyurethane elastomer is based on polycarbonate, at least one polyol is a polycarbonate polyol. In this case, more than 80% by weight, or even more than 90% by weight, of the total sum of the polyols is preferably based on polycarbonate polyols.

When the thermoplastic polyurethane elastomer is based on polyether, at least one polyol is a polyether polyol. In this case, more than 80% by weight, or even more than 90% by weight, of the total sum of the polyols is preferably based on polyether polyols.

The polyol may be chosen from those having a number-average molecular mass (Mn) ranging from 200 g/mol to 20 000 g/mol, preferably from 400 g/mol to 18 000 g/mol.

The number-average molecular mass of the polyols can be calculated from the hydroxyl number (OHN), expressed in mg KOH/g, and from the functionality of the polyol, or determined by methods well known to those skilled in the art, for example by size exclusion chromatography (or SEC) with PEG (polyethylene glycol) standard.

Preferably, the polyols have a hydroxyl functionality ranging from 2 to 6. In the context of the invention, and unless otherwise mentioned, the hydroxyl functionality of a polyol is the mean number of hydroxyl functions per mole of polyol.

The polyether polyols may be chosen from polyoxyalkylene polyols in which the linear or branched alkylene part comprises from 2 to 4 carbon atoms.

The polyether polyols may be chosen from polyoxyalkylene diols or polyoxyalkylene triols in which the linear or branched alkylene part comprises from 1 to 4 carbon atoms.

Examples of polyoxyalkylene diols or triols include:
polyoxypropylene diols or triols (also denoted by polypropylene glycol (PPG) diols or triols) having a number-average molecular mass (Mn) ranging from 300 to 20 000 g/mol;
polyoxyethylene diols or triols (also denoted by polyethylene glycol (PEG) diols or triols) having a number-average molecular mass (Mn) ranging from 300 to 15 000 g/mol;
polyoxybutylene diols or triols (also denoted by (PBG) diols or triols) having a number-average molecular mass ranging from 300 to 20 000 g/mol;
polytetramethylene diols or triols (also denoted by polyTHF or PTMEG) having a number-average molecular mass (Mn) ranging from 300 to 4000 g/mol;
diol or triol copolymers or terpolymers based on ethylene oxide, propylene oxide and/or butylene oxide having a number-average molecular mass (Mn) ranging from 300 to 4000 g/mol;
and mixtures thereof.

The abovementioned polyether polyols may be prepared conventionally and are widely available commercially. They may be obtained by polymerization of the corresponding alkylene oxide in the presence of a basic catalyst (for example potassium hydroxide) or a catalyst based on a double metal/cyanide complex.

The polyester polyols may be chosen from the polyester polyols resulting from the polycondensation:
of one or more aliphatic (linear, branched or cyclic) or aromatic polyols, for instance monoethylene glycol, diethylene glycol, 1,2-propanediol, 1,3-propanediol, 1,4-butanediol, butenediol, 1,6-hexanediol, cyclohexanedimethanol, tricyclodecanedimethanol, neopentyl glycol, cyclohexanedimethanol, glycerol, trimethylolpropane, 1,2,6-hexanetriol, sucrose, glucose, sorbitol, pentaerythritol, mannitol, N-methyldiethanolamine, triethanolamine, a fatty alcohol dimer, a fatty alcohol trimer, and mixtures thereof, with
one or more polycarboxylic acids or their ester or anhydride derivatives such as 1,6-hexanedioic acid (adipic acid), methyl adipic acid, dodecanedioic acid, azelaic acid, sebacic acid, adipic acid, 1,18-octadecanedioic acid, phthalic acid, isophthalic acid, suberic acid, oxalic acid, terephthalic acid, succinic acid, a dimer fatty acid, a trimer fatty acid and mixtures of these acids, an unsaturated anhydride such as, for example, maleic or phthalic anhydride, or a lactone such as, for example, caprolactone.

The abovementioned polyester polyols may be prepared conventionally and are for the most part available commercially.

The polyester polyol is preferably chosen from polybutyl adipate, polyglycol sebacate, poly(caprolactone), and polyesters based on fatty acid dimer.

The polycarbonate polyols may have a number-average molecular mass (Mn) ranging from 500 to 12 000 g/mol, preferably from 500 to 5000 g/mol, and more preferably from 1000 to 3000 g/mol.

The polycarbonate polyols may be chosen from polycarbonate polyols obtained by ring-opening polymerization of an alkylene carbonate, by transesterification of a diol compound with a chloroformate, or by reaction of a polyol with phosgene or a dialkyl carbonate (or diaryl carbonate).

The dialkyl carbonates may be C1-C4 alkyl carbonates such as, for example, dimethyl carbonate and diethyl carbonate.

The polyol is preferably chosen from polyether polyols.

The chain extenders may be chosen from diols and diamines.

Examples of chain extender diols include ethylene glycol, propylene glycol, 1,4-butanediol, butenediol, butynediol, xylylene glycols, amylene glycols, 1,4-phenylene bis-beta-hydroxyethyl ether, 1,3-phenylene bis-beta-hydroxyethyl ether, bis-(hydroxymethylcyclohexane), hexanediol, thiodiglycol, and mixtures thereof.

Examples of chain extender diamines include ethylene diamine, propylene diamine, butylene diamine, hexamethylene diamine, cyclohexaenediamine, phenylene diamine, tolylene diamine, xylylene diamine, and mixtures thereof.

The chain extenders may have a number-average molecular mass (Mn) ranging from 50 to 600 g/mol.

The thermoplastic polyurethane elastomers may be obtained by any conventional method, for example in one or two steps. The reaction may be performed in the presence of a catalyst. Typical catalysts may be organotins, tertiary amines, zinc salts or manganese salts.

The thermoplastic polyurethane elastomer may comprise from 40% to 80% by weight, preferably from 50% to 70% by weight, of hard blocks relative to the total weight of said elastomer.

The thermoplastic polyurethane elastomer is preferably a polyether-based polyurethane.

According to one preferred embodiment, the thermoplastic polyurethane elastomer is a polyether-based thermoplastic polyurethane elastomer, obtained from at least one aromatic polyisocyanate, at least one polyether polyol chosen from polyoxyalkylene diols or triols, and optionally at least one diol as chain extender.

The adhesive layer may comprise a thermoplastic polyurethane elastomer as defined above, or a mixture of at least two thermoplastic polyurethane elastomers as defined above.

The thermoplastic polyurethane elastomer may especially be one of the products marketed by BASF under the ELASTOLLAN® series, by LUBRIZOL under the Estane® series, by COVESTRO under the DESMOPAN® series, or by Dow Chemicals under the Pellethane® series. Mention may be made, for example, of Pellethane® 2103-70A (more than 98% thermoplastic polyurethane elastomer obtained from methylenediphenyl diisocyanate, 1,4-butanediol and polytetramethylene glycol), or else Elastollan® 1170 A10, 1175 A10W, from BASF.

The melting temperature of the thermoplastic polyurethane elastomer used in the adhesive layer may be greater than or equal to 80° C., preferably greater than or equal to 100° C., even more preferably greater than or equal to 130° C.

The melting temperature of the thermoplastic polyurethane elastomer used in the adhesive layer may be less than or equal to 250° C., preferably less than or equal to 220° C., and even more preferably less than or equal to 200° C.

The melting temperature can be determined by DSC (scanning calorimeter).

The thermoplastic polyurethane elastomer may have a Shore A hardness ranging from 30 to 100, preferably from 50 to 95, and even more preferably from 70 to 95. The Shore A hardness can be measured as described in standard DIN ISO 7619-1 (3 s).

The thermoplastic polyurethane elastomer may have a Shore D hardness ranging from 5 to 60, preferably from 10 to 50, and even more preferably from 20 to 46. The Shore D hardness can be measured as described in standard DIN ISO 7619-1 (3 s).

The thermoplastic polyurethane elastomer may have a melt mass flow index (denoted MFR) ranging from 10 to 50 g/10 min, preferably from 15 to 45 g/10 min, and even more preferably from 25 to 35 g/10 min. The MFR is measured according to standard ISO 1133 for a temperature of 190° C. and a total weight of 21.6 kg).

The adhesive layer may further comprise at least one additive selected from the group consisting of pigments, fillers, dispersants, dyes, antioxidants, stabilizers, flame retardants, and mixtures thereof.

The total additive content may range from 0.01% to 5%, preferably from 0.01% to 2%, relative to the total weight of said adhesive layer.

The adhesive layer may comprise one or more non-elastomeric polymers, such as, for example, a polyolefin resin, a polystyrene resin or an ethylene-vinyl acetate copolymer.

Preferably, the adhesive layer comprises more than 90% by weight of thermoplastic polyurethane elastomer as defined above, preferably more than 95% by weight, and even more advantageously more than 99% by weight relative to the total weight of said adhesive layer.

The adhesive layer may have a total thickness ranging from 5 to 60 um, preferably from 15 to 50 μm, and even more preferably from 20 to 40 μm.

### Barrier Layer

The barrier layer comprises a thermoplastic polyester elastomer.

The barrier layer makes it possible especially to protect the bonded substrate and to make it impervious to certain gases (example: air) and fluids (example: water).

The term “thermoplastic polyester elastomer” is well known to those skilled in the art, and is also designated by the initials “TPC”. It concerns a block copolymer comprising, in alternation, so-called hard or rigid blocks or segments, and so-called soft or flexible blocks or segments, with ester bonds in the hard blocks, and optionally ester and/or ether and/or carbonate bonds in the soft blocks.

The thermoplastic polyester elastomer may be of polyester-polyester type (with especially the soft segment comprising a polyester) or polyester-polyether type (with especially the soft segment comprising a polyether) or polyester-polyester/polyether type (with especially the soft segment comprising a polyester-polyether copolymer).

A thermoplastic polyester-polyester elastomer may comprise an aromatic polyester as a hard segment and an aliphatic polyester as a soft segment.

A thermoplastic polyester-polyether elastomer may comprise an aromatic polyester as a hard segment and an aliphatic polyether as a soft segment.

The hard segment of a thermoplastic polyester elastomer may be a segment comprising a polyester formed of an aromatic polyester prepared, for example, from an aromatic dicarboxylic acid and a diol.

Examples of aromatic dicarboxylic acids include terephthalic acid, isophthalic acid, phthalic acid, naphthalene-2,6-dicarboxylic acid, naphthalene-2,7-dicarboxylic acid, anthracene dicarboxylic acid, biphenyl-4,4-dicarboxylic acid, diphenoxyethanedicarboxylic acid, 4,4′-diphenyl ether dicarboxylic acid, 5-sulfoisophthalic acid, and sodium 3-sulfoisophthalate.

The aromatic polyester may be prepared from a single aromatic dicarboxylic acid or a mixture of such acids.

The diol may be chosen from those having a molar mass of less than or equal to 400 g/mol. It may for example be chosen from:
aliphatic diols such as, for example, 1,4-butanediol, ethylene glycol, trimethylene glycol, pentamethylene glycol, hexamethylene glycol, neopentyl glycol, decamethylene glycol or mixtures thereof;
aromatic diols such as, for example, xylylene glycol, bis(p-hydroxy)biphenyl, bis(p-hydroxy)diphenylpropane, 2,2′-bis[4-(2-hydroxyethoxy)phenyl]propane, bis[4-(2-hydroxyethoxy)phenyl] sulfone, 1,1-bis[4-(2-hydroxyethoxy)phenyl]cyclohexane, 4,4′-hydroxy-p-terphenyl, or mixtures thereof;
mixtures thereof.

The aromatic polyester is preferably prepared from an aromatic dicarboxylic acid such as, for example, terephthalic acid, and an aliphatic diol such as, for example, 1,4-butanediol.

According to a preferred embodiment, the hard segment of the thermoplastic polyester elastomer comprises a polyester chosen from polybutylene terephthalate, polyethylene terephthalate and polytrimethylene terephthalate, and even more preferably polybutylene terephthalate.

The soft segment of the thermoplastic polyester elastomer may comprise an aliphatic polyether and/or an aliphatic polyester, preferably an aliphatic polyether.

The aliphatic polyether may be a poly(ethylene oxide) glycol, a poly(propylene oxide) glycol, a poly(tetramethylene oxide) glycol, poly(hexamethylene glycol), a copolymer of ethylene oxide and propylene oxide, or a glycol copolymer of ethylene oxide and tetrahydrofuran.

The aliphatic polyester may be a poly(ε-caprolactone), a polyenanthractone, a polycaprolactone, a polybutylene adipate or a polyethylene adipate.

The thermoplastic polyester elastomer may be modified with an unsaturated carboxylic acid, such as, for example, acrylic acid, maleic acid, fumaric acid, or derivatives thereof.

According to one preferred embodiment, the soft segment of the thermoplastic polyester elastomer comprises an aliphatic polyether chosen from poly(tetramethylene oxide) glycol or poly(hexamethylene glycol).

The content of hard segments in the thermoplastic polyester elastomer of the barrier layer may range from 10% by weight to 60% by weight, preferably from 20% by weight to 40% by weight relative to 100% by weight of thermoplastic polyester elastomer.

The content of soft segments in the thermoplastic polyester elastomer of the barrier layer may range from 30% to 90% by weight, preferably from 50% to 80% by weight relative to 100% by weight of thermoplastic polyester elastomer.

Preferably, the thermoplastic polyester elastomer is a thermoplastic polyester-polyether.

The melting temperature of the thermoplastic polyester elastomer of the barrier layer may be greater than or equal to 90° C., preferably greater than or equal to 150° C., and even more preferably greater than or equal to 180° C.

The melting temperature of the thermoplastic polyester elastomer of the barrier layer may be less than or equal to 250° C., preferably less than or equal to 220° C.

The melting temperature can be determined by DSC (scanning calorimeter).

The thermoplastic polyester elastomer may have a Shore D hardness ranging from 30 to 80, preferably from 40 to 70, and even more preferably from 40 to 60. The Shore D hardness can be measured as described in standard DIN ISO 7619-1.

The barrier layer may comprise one or more thermoplastic polyester elastomers as described above.

There are thermoplastic polyester elastomers sold, for example, by Toray Dupont under the Hytrel™ series or else the Arnitel™ series sold by DSM. In particular, mention may be made of Arnitel EL630 (poly(ether-ester) copolymers) from DSM, or HYTREL® 6356 from DUPONT.

The barrier layer may comprise at least one additive selected from the group consisting of pigments, fillers, dispersants, dyes, flame retardants, antioxidants, stabilizers, and mixtures thereof.

The total additive content may range from 0% to 5%, preferably from 0.01% to 5%, and even more preferably from 0.01% to 2% by weight relative to the total weight of said barrier layer.

The barrier layer may comprise one or more non-elastomeric polymers, such as, for example, a polyolefin resin, a polystyrene resin or an ethylene-vinyl acetate copolymer.

Preferably, the barrier layer comprises more than 95% by weight of thermoplastic polyester elastomer as defined above, preferably more than 98% by weight, and even more advantageously more than 99% by weight, and even more preferably more than 99.9% by weight relative to the total weight of said barrier layer.

Preferably, the barrier layer does not comprise polymers other than the thermoplastic polyester elastomer as defined above.

The barrier layer may have a total thickness ranging from 5 to 40 μm, preferably from 5 to 30 μm, and even more preferably from 10 to 25 μm.

According to one embodiment, the melting temperature of the barrier layer is higher than the melting temperature of the adhesive layer. This advantageously allows the adhesive layer to adhere to a substrate by heating to a temperature lower than the melting temperature of the barrier layer. Hence, the adhesive layer is melted or softened sufficiently for adhesion to the substrate while avoiding softening or melting of the barrier layer, and thus maintaining the properties of the barrier layer.

### Multilayer Film

The multilayer film according to the invention comprises a barrier layer and an adhesive layer as defined above.

The above-mentioned adhesive layer may comprise one or more adhesive layers of identical or different kinds.

The above-mentioned barrier layer may comprise one or more barrier layers of identical or different kinds.

According to a preferred embodiment, the multilayer film comprises a single barrier layer and a single adhesive layer.

The total thickness of the multilayer film may range from 6 to 80 μm, preferably from 10 to 60 μm.

The present invention also relates to a process for preparing a multilayer film as described above. The process may comprise a coextrusion step, such as, for example, blown film coextrusion, or flat die coextrusion.

In a manner known to those skilled in the art, the blown film coextrusion process comprises:
melting, in separate extruders, the constituent compositions of the adhesive and barrier layers; then
passing the corresponding flows through an annular and concentric die, so as to form a tubular bubble with several layers, then
radially expanding (relative to the annular die) and stretching (in the axial direction) the bubble; then
cooling the bubble.

The geometrical characteristics of the dies, as well as the process parameters such as the radial expansion rate and the stretching speed, can be set so as to obtain the desired thickness for the various constituent layers of the multilayer film.

### Laminates/Uses

The present invention also relates to the use of the multilayer film as defined above for preparing laminate.

The present invention relates to the preparation of a laminate, comprising:
supplying a multilayer film as defined above;
bonding the multilayer film on a substrate.

The bonding step can be carried out by laminating the film on the substrate and heating to a temperature below the melting temperature of the barrier layer (for example after or during deposition on the substrate).

The adhesive layer is in particular the layer of the multilayer film which is in contact with the substrate to which adhesion is to take place, which advantageously allows the barrier layer of the multilayer film to adhere to the substrate.

The substrate may be of a variety of kinds. It can be a substrate chosen from foams, textiles, plastics, metals, elastomers, thermosets, and composites.

The textiles may be based on synthetic fibers, natural fibers, semi-synthetic fibers, inorganic fibers, or mixtures thereof.

Among the synthetic fibers, mention may be made, for example, of copolymers based on polyamide (such as, for example, nylon), polyesters (such as, for example, polybutylene terephthalate PBT, polyethylene terephthalate PET), polyether ketones, and/or polyolefins.

The multilayer film is preferably intended for application to a textile. More particularly, the multilayer film is intended to be applied to a textile by means of its adhesive layer.

The present invention relates to the use of the multilayer film, or of the laminate, as defined above, for bonding/preparing parts, for example parts present in the automobile passenger compartment, or for preparing airbags.

The parts thus formed can be used for soundproofing in the automotive field (such as, for example, in the engine hood, trunk floor, floor carpets, etc.), for safety, or for decoration.

All the embodiments described above may be combined with each other.

In the context of the invention, the term “between x and y” or “ranging from x to y” means a range in which the limits x and y are included. For example, the range “between 0% and 25%” notably includes the values 0% and 25%.

The invention is now described in the following implementation examples, which are given purely by way of illustration and should not be interpreted in order to limit the scope thereof.

### EXAMPLES

### Example 1: Preparation of the Multilayer Film (Film F1) by Blown Film Coextrusion

A thermoplastic polyester elastomer comprising a polyether soft segment, having the following characteristics, is used as composition B, constituting the barrier layer: Melting point (ISO 11357-3): 207° C., Hardness (ISO 868): 51D, MVR melt volume flow index (ISO 133): 36 cm³/10 min (230° C.; 2.16 kg).

A polyether-based thermoplastic polyurethane elastomer having the following characteristics is used as composition A, constituting the adhesive layer: Melting range (ISO 11357-3): 150-180° C., Hardness (ISO 7619-1): 36D, MFR melt mass flow index (ISO 1133): 30 g/10 min (190° C.; 21.6 kg).

The film F1 is manufactured on a blown film coextrusion line with at least 3 screw extruders.

The process parameters are adjusted to produce a two-layer film comprising:
an adhesive layer with a thickness of 35 μm consisting of composition A;
a barrier layer with a thickness of 15 μm consisting of composition B.

Among the parameters usually set, mention may be made of:
Extruder temperatures of the adhesive layer between 170 and 210° C.,
Extruder temperatures of the barrier layer between 210 and 250° C.,
Die temperatures between 210 and 250° C.,
The blow-up ratio (BUR) used is between 1.2 and 3.

The two-layer film thus obtained has a total thickness of 50 μm and a length of 50 m linear.

### Example 2: Comparative Multilayer Film (Film F2)

A thermoplastic polyester elastomer comprising a polyether soft segment, having the following characteristics, is used as composition B, constituting the barrier layer: Melting point (ISO 11357-3): 207° C., Hardness (ISO 868): 51D, MVR melt volume flow index (ISO 133): 36 cm³/10 min (230° C.; 2.16 kg).

A polyester-based thermoplastic polyurethane elastomer, having the following characteristics, is used as composition A, constituting the adhesive layer: Melting range (ISO 11357-3): 150-180° C., Hardness (ISO 7619-1): 85 A, MFR melt mass flow index (ISO 1133): 10 g/10 min (190° C.; 21.6 kg).

The film F2 is manufactured on a blown film coextrusion line with at least 3 screw extruders.

The process parameters are adjusted to produce a two-layer film comprising:
an adhesive layer with a thickness of 30 μm consisting of composition A;
a barrier layer with a thickness of 20 μm consisting of composition B.

Among the parameters usually set, mention may be made of:
Extruder temperatures of the adhesive layer between 170 and 210° C.,
Extruder temperatures of the barrier layer between 210 and 250° C.,
Die temperatures between 210 and 250° C.,
The blow-up ratio (BUR) used is between 1.2 and 3.

The two-layer film thus obtained has a total thickness of 50 μm and a length of 50 m linear.

### Example 3: Performance

To simulate the aging of a film, the following tests were carried out on the two-layer film F1 (example 1, according to the invention) and on a two-layer film F2 (comparative, example 2) according to the following tests.

### Tensile Tests

Tensile tests according to the ISO 527-3 standard were carried out on the films F1 (example 1) and F2 (comparative, example 2) which were not aged and also on the films aged at 70° C. and 95% RH up to 3000 h. This test makes it possible to evaluate the evolution of the mechanical properties of the films over time during this type of aging.

### Film Aging

The films were placed in a climate chamber with the following settings:
Chamber temperature: 70° C.
Humidity set to 95% RH
Duration of the test: 3000 h

The results of the tensile tests are given in the following table:

| | | Machine | Cross |
|---|---|---|---|
| | | direction yield | direction yield |
| Film reference | Aging time (h) | stress (MPa) | stress (MPa) |
| Film F2 | 0 | 51.8 | 61.1 |
| (comparative) | 408 | 57.6 | 57.9 |
| | 1632 | 50.9 | 54.1 |
| | 2016 | 13.6 | 13.2 |
| Film F1 (example | 0 | 59.6 | 56.0 |
| 1) | 480 | 61.6 | 53.6 |
| | 1584 | 59.0 | 56.4 |
| | 2280 | 54.0 | 54.0 |
| | 3000 | 50.5 | 50.8 |

The film F1 according to the invention advantageously leads to a stable yield stress around 50-60 MPa up to 3000 h of aging.

On the other hand, a drop in the yield stress is observed at about 2000 h, with the comparative film F2. The adhesive layer of the film is completely degraded.

### Peel Tests

Peel tests according to the ISO 11339 standard (test speed 100 mm/min, load cell 1 kN) were carried out on bonded assemblies “polyester textile/single-layer adhesive film/polyester textile” not aged and aged at 70° C. and 95% RH up to 3000 h.

The peel tests are used to measure the adhesive strength of the films on polyester textile. However, since the adhesive strength of the film F1 or F2 on the polyester textile is greater than the mechanical strength of the film, this does not allow the film to be peeled off. To overcome this, an alternative method was developed to control the adhesion properties of the films. This method involves assembling 2 polyester textiles with a single-layer film of the same composition as the adhesive layer of the film F1 (example 1) (and respectively a single-layer film of the same composition as the adhesive layer of the comparative film F2), with a thickness which is doubled (60 to 70 μm depending on the film, i.e., 2 times the thickness of the adhesive layer of the two-layer film) as there are 2 textiles to be bonded. In addition, a strip of silicone paper was positioned inside the assembly as follows:

### Film F′1

Polyester textile
Silicone paper leader
(thickness 80 μm)
70 μm single-layer film -
adhesive layer of film F1
Polyester textile

### Film F′2

Polyester textile
Silicone paper leader
(thickness 80 μm)
60 μm single-layer film -
adhesive layer of film F2
Polyester textile

### Film Preparation

The textile and film were cut into dimensions of 120×250 mm (in the machine direction of extrusion and weaving).

A platen press was powered up and the following settings were made:
Temperature of the upper and lower platens at 180° C.
Press pressure set at 4 bar
Bonding time: 60 s.

Once the bonding had been carried out, the assembly was cooled to 23° C. and subjected to the peel test (initial peel).

After a minimum of 24 h, the films were then aged according to the protocol mentioned above. The films were then cut out into test pieces in the 50×250 mm format and subjected to the peel test.

The results are given in the following table:

| | | Peel strength |
|---|---|---|
| Film reference | Aging time (h) | (N/mm) |
| Comparative film F′2 with | 0 (initial peel) | 0.91 |
| adhesive layer of the film of | 1560 | 0.15 |
| example 2 | | |
| Film F′1 with adhesive layer of the | 0 (initial peel) | 1.36 |
| film of example 1 | 1584 | 0.61 |
| | 3000 | 0.62 |

The film F′1 with the adhesive layer of the film F1 advantageously has an initial peel strength of 1.36 N/mm, greater than the peel strength of the film F′2 with the adhesive layer of the film F2. After 1500 h of aging, the film F′1 advantageously has a peel strength greater than 0.6 N/mm, markedly greater than that of the peel strength of the film F′2, which is almost zero.

In conclusion, the F1 film advantageously leads to good mechanical and adhesion properties after aging under conditions of 70° C. and 95% RH.

1-18. (canceled)

19. A multilayer film comprising:
an adhesive layer comprising a thermoplastic polyurethane elastomer selected from the group consisting of polyether-based thermoplastic polyurethane elastomers, polycarbonate-based thermoplastic elastomers, and mixtures thereof;
a barrier layer bonded to the adhesive layer, said barrier layer comprising a thermoplastic polyester elastomer.

20. The multilayer film as claimed in claim 19, characterized in that the thermoplastic polyurethane elastomer is the reaction product of at least one polyol, a polyisocyanate, and optionally a chain extender.

21. The multilayer film as claimed in claim 20, characterized in that the polyisocyanate is chosen from diisocyanates.

22. The multilayer film as claimed in claim 20, characterized in that the polyol is chosen from polyether polyols.

23. The multilayer film as claimed in claim 19, characterized in that the thermoplastic polyurethane elastomer is a polyether-based thermoplastic polyurethane elastomer.

24. The multilayer film as claimed in claim 19, characterized in that the thermoplastic polyurethane elastomer has a Shore A hardness ranging from 30 to 100.

25. The multilayer film as claimed in claim 19, characterized in that the thermoplastic polyurethane elastomer has a Shore D hardness ranging from 5 to 60.

26. The multilayer film as claimed in claim 19, characterized in that the adhesive layer comprises more than 90% by weight of thermoplastic polyurethane elastomer, by weight relative to the total weight of said adhesive layer.

27. The multilayer film as claimed in claim 19, characterized in that the thermoplastic polyester elastomer is of the polyester-polyester or polyester-polyether or polyester-polyester/polyether type.

28. The multilayer film as claimed in claim 19, characterized in that the hard segment of the thermoplastic polyester elastomer comprises a polyester selected from the group consisting of polybutylene terephthalate, polyethylene terephthalate and polytrimethylene terephthalate.

29. The multilayer film as claimed in claim 19, characterized in that the soft segment of the thermoplastic polyester elastomer comprises an aliphatic polyether and/or an aliphatic polyester.

30. The multilayer film as claimed in claim 29, characterized in that:
the aliphatic polyether is a poly(ethylene oxide) glycol, a poly(propylene oxide) glycol, a poly(tetramethylene oxide) glycol, poly(hexamethylene glycol), a copolymer of ethylene oxide and propylene oxide, or a glycol copolymer of ethylene oxide and tetrahydrofuran; and
the aliphatic polyester is a poly(ε-caprolactone), a polyenanthractone, a polycaprolactone, a polybutylene adipate, or a polyethylene adipate.

31. The multilayer film as claimed in claim 19, characterized in that the thermoplastic polyester elastomer has a Shore D hardness ranging from 30 to 80.

32. The multilayer film as claimed in claim 19, characterized in that the barrier layer comprises more than 95% by weight of thermoplastic polyester elastomer, relative to the total weight of said barrier layer.

33. The multilayer film as claimed in claim 19, characterized in that the total thickness of said multilayer film ranges from 6 to 80 μm.

34. A process for preparing the multilayer film as defined according to claim 19, the process comprising a coextrusion step.

35. A laminate comprising the multilayer film as defined according to claim 19.

36. Packaging comprising the multilayer film as defined according to claim 19.

37. The multilayer film as claimed in claim 21, characterized in that the polyisocyanate is selected from the group consisting of isophorone diisocyanate (IPDI), hexamethylene diisocyanate (HDI), heptane diisocyanate, octane diisocyanate, nonane diisocyanate, decane diisocyanate, undecane diisocyanate, dodecane diisocyanate, 2,4′-methylenebis(cyclohexyl isocyanate) (2,4′-H6MDI), 4,4′-methylenebis(cyclohexyl isocyanate) (4,4′-H6MDI), norbornane diisocyanate, norbornene diisocyanate, cyclohexane 1,4-diisocyanate (CHDI), methylcyclohexane diisocyanate, ethylcyclohexane diisocyanate, propylcyclohexane diisocyanate, methyldiethylcyclohexane diisocyanate, cyclohexanedimethylene diisocyanate, 1,5-diisocyanato-2-methylpentane (MPDI), 1,6-diisocyanato-2,4,4-trimethylhexane, 1,6-diisocyanato-2,2,4-trimethylhexane (TMDI), 4-isocyanatomethyloctane 1,8-diisocyanate (TIN), 2,5-bis(isocyanatomethyl)bicyclo[2.2.1]heptane (2,5-NBDI), 2,6-bis(isocyanatomethyl)bicyclo[2.2.1]heptane (2,6-NBDI), bis(isocyanatomethyl)cyclohexane (H6-XDI), xylylene diisocyanate (XDI), toluene diisocyanate and/or toluene 2,6-diisocyanate (2,6-TDI)), diphenylmethane diisocyanate and/or diphenylmethane 2,4′-diisocyanate (2,4′-MDI)), tetramethylxylylene diisocyanate (TMXDI), and mixtures thereof.
